(19) United States
(12) Patent Application Publication
(10) Pub. No.: US 2007/0230148 A1
(43) Pub. Date: Oct. 4, 2007

(54) System and method for interconnecting node boards and switch boards in a computer system chassis

(76) Inventors: Edoardo Campini, Mesa, AZ (US); David Formisano, Chandler, AZ (US); Eric M. Mantion, Chandler, AZ (US)

Correspondence Address: Grossman, Tucker, Perreault & Pfleger, PLLC;PortfolioIP, P.O. Box 52050, Minneapolis, MN, 55402, US

(21) Appl. No.: 11/395,919

(22) Filed: Mar. 31, 2006

(51) Int. Cl. H01R 12/16

(52) U.S. Cl. 361/788

(57) ABSTRACT

An interconnect system may be used to interconnect node boards and one or more switch boards coupled to a common backplane in a computer system shelf or chassis. The interconnect system may interconnect the node boards and switch board(s) using external signal paths external to the backplane. In one embodiment, the signal paths may be connected to a rear transition module (RTM) that provides conversion between electrical node board signals and optical switch board signals. Of course, many alternatives, variations, and modifications are possible without departing from this embodiment.

### FIELD

The present disclosure relates to the interconnection of node boards and switch boards in a computer system chassis, such as an Advanced Telecommunications Computing Architecture (ATCA) chassis.

### BACKGROUND

In computer systems, such as an Advanced Telecommunications Computer Architecture (ATCA) system, a plurality of circuit boards (also referred to as blades) may be coupled to and interconnected via a common backplane within a shelf or chassis. The circuit boards may include a plurality of node boards and one or more switch boards interconnected according to a topology. In a star topology, for example, each of the node boards may be coupled to a single switch board and the single switch board provides interconnectivity between each of the node boards. According to a dual star topology, each of the node boards may be coupled to redundant switch boards and the redundant switch boards provide redundant interconnects between the node boards.

The node boards and the switch board(s) may be interconnected via signal traces routed across the common backplane between node slots configured to receive the node boards and switch slots configured to receive the switch boards (referred to as an interconnect fabric). The number of interconnections that may be made between node boards and switch boards using the backplane may be limited. To maintain signal integrity, a backplane may only capable of routing a limited number of signal traces and each signal trace may be capable of a limited signal frequency or bandwidth. In an ATCA backplane, for example, each of the node slots is coupled to each switch slot with one fabric channel (e.g., 8 differential signal pairs) through the backplane. Such a limited interconnectivity may result in a bottleneck between the node boards and the switch boards, for example, when trying to support applications requiring a high performance fabric interface.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a side schematic view of a computer system chassis including circuit boards coupled to a common backplane, consistent with one embodiment of the present disclosure;

FIG. 2 is a top schematic view of a system for interconnecting node boards and a switch board using a rear transition module (RTM), consistent with one embodiment of the present disclosure;

FIG. 3 is a functional block diagram illustrating a system for interconnecting node boards and a switch board by providing conversion between node board signals and switch board signals, consistent with one embodiment of the present disclosure;

FIG. 4 is a top schematic view of a rear transition module (RTM) coupled to node slots of a backplane using flexible film circuits, consistent with one embodiment of the present disclosure;

FIG. 5 is a rear schematic view of a backplane in a computing system including two RTMs coupled to a node slot using flexible film circuits, consistent with another embodiment of the present disclosure;

FIG. 6 is diagrammatic view of node boards interconnected with redundant switch boards using an interconnect system, consistent with another embodiment of the present disclosure;

FIG. 7 is a top schematic view of a system for interconnecting node boards and a switch board using interconnect modules and optical fibers coupled to node slots, consistent with a further embodiment of the present disclosure; and

FIG. 8 is a perspective view of a system including a cabinet and a plurality of chassis, consistent with another embodiment of the present disclosure.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

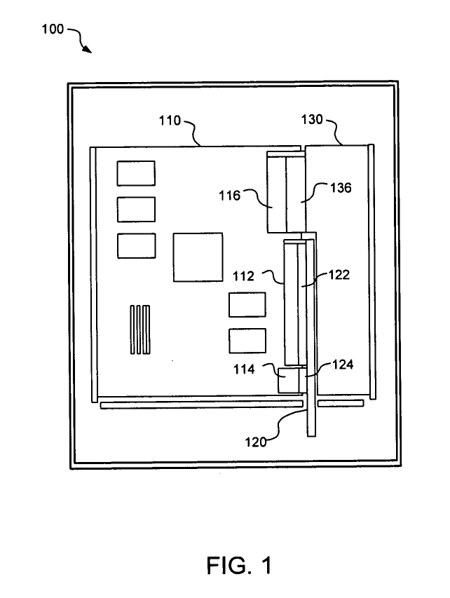

Referring to FIG. 1, a system and method for interconnecting node boards and switch boards may be used in a computer system shelf or chassis 100. The chassis 100 may include a plurality of circuit boards 10 coupled to and interconnected via a common backplane 120 (only one circuit board 110 is shown in the side view of FIG. 1). As described in greater detail below, the circuit boards 110 may include node boards that provide application functionality (e.g., single blade computers, storage blades, network processing and I/O blades) and switch boards that provide switching interconnectivity between the node boards (e.g., fabric switches). Node boards and switch boards may be interconnected according to various topologies described in greater detail below. Node boards may communicate, for example, by transferring/receiving packets to/from the switch board(s), which transfers the packets to/from one or more node boards.

In the chassis 100, the backplane 120 may include backplane slot connectors 122, 124 configured to connect to mating board connectors 112, 114 on the circuit boards 110. The backplane slot connectors 122, 124 may include data transport connectors 122 configured to provide data connections between circuit boards 110 and the backplane 120. The backplane 120 may include signal paths (e.g., traces) routed through the backplane 120 between data transport connectors 122 to provide interconnections between the circuit boards 110 and other components in the chassis 100 (e.g., to a shelf management controller). The backplane slot connectors 122, 124 may also include power connectors 124 configured to provide power connections between the circuit boards 110 and a power feed.

The circuit board(s) 110 may be located on a first (or front) side of the backplane 120. The chassis 100 may also include one or more rear transition modules (RTMs) 130 (e.g., additional circuit boards) located on a second (or rear) side of the backplane 120 opposite one or more corresponding circuit boards 110. The RTM 130 may include a RTM connector 136 configured to connect to a mating board connector 116 on the corresponding circuit board 110. As described in greater detail below, external signal paths may be coupled between node slots and RTM 130 to couple node boards to a switch board.

The computer system chassis 100 may be an advanced telecommunications computing architecture (Advanced TCA or ATCA) chassis complying with or compatible with, at least in part, PCI Industrial Computer Manufacturers Group (PICMG), Advanced Telecommunications Computing Architecture (ATCA) Base Specification, PICMG 3.0 Rev. 2.0, published Mar. 18, 2005, and/or later versions of the specification (“the ATCA specification”). According to such an embodiment, the circuit boards 110 may be ATCA blades complying with or compatible with, at least in part, the ATCA Specification.

Various other embodiments consistent with the present disclosure may include a chassis and/or circuit boards complying with and/or compatible with technical specifications other than and/or in addition to the ATCA Specification. A system for interconnecting node boards and switch boards may be used, for example, in other types of chassis including, but not limited to, VME chassis and CompactPCI chassis. An interconnect system may also be implemented in other chassis including a plurality of parallel circuit boards (e.g., blades) coupled to a backplane, such as the type available under the name IBM BladeCenter®. The scope of the present disclosure should not, therefore, be construed as being limited to any particular computer system or form factor.

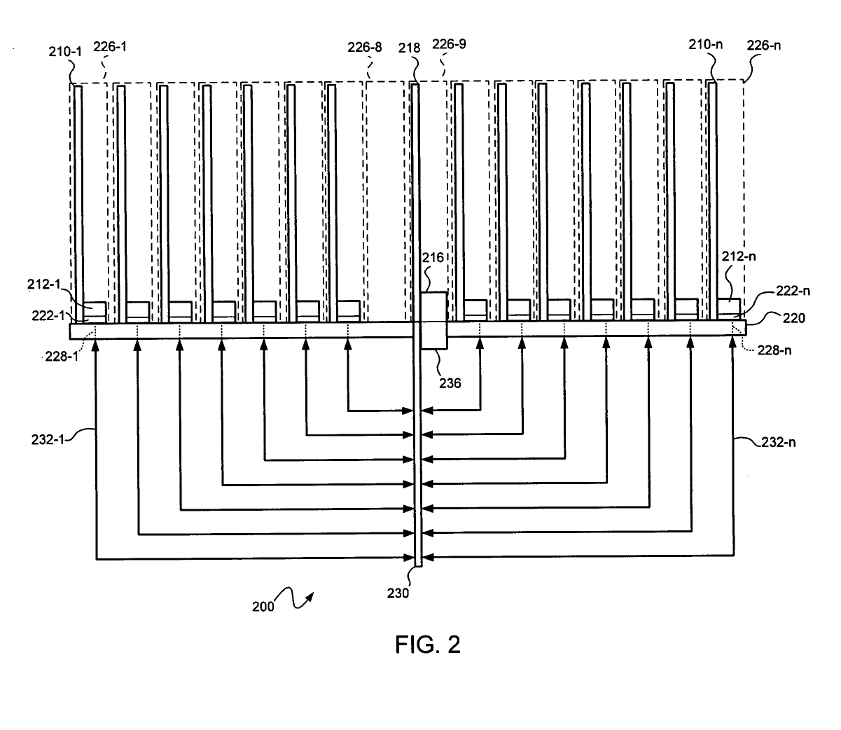

Referring to FIG. 2, one embodiment of an interconnect system 200 for interconnecting node boards and at least one switch board is shown in greater detail. The backplane 220 may include a plurality of slots 226-1 to 226-n on the first side of the backplane 220 for receiving a plurality of circuit boards 210-1 to 210-n and 218. In an ATCA chassis, for example, the backplane 220 may include fourteen (14) node slots and two (2) switch slots. In the illustrated embodiment, slots 226-8 and 226-9 are switch slots and a switch board 218 is located in switch slot 226-9. The remaining slots in this embodiment are node slots that receive node boards 210-1 to 210-n. According to a star topology (as shown in FIG. 2), the interconnect system 200 may couple one switch board 218 to a plurality of node boards 210-1 to 210-n. According to a dual star topology, the interconnect system 200 may couple two switch boards 218 to a plurality of node boards 210-1 to 210-n. The interconnect system 200 may be used, however, to interconnect node boards and switch boards according to other topologies (e.g., a dual-dual star topology).

The backplane 220 may include slot connectors 222-1 to 222-n associated with each of the slots 226-1 to 226-n and configured to connect to mating board connectors 212-1 to 212-n on respective circuit boards 210-1 to 210-n and 218. According to one example, the slot connectors 222-1 to 222-n may be data transport connectors such as the type available from Tyco under the name ZD connector. Conductors 228-1 to 228-n extend from the slot connectors 222-1 to 222-n through the backplane 220 to the second side of the backplane 220. The conductors 228-1 to 228-n may be pins extending from the slot connectors 222-1 to 222-n or separate conductors (e.g., vias) coupled to the pins in the slot connectors 222-1 to 222-n. Although only one conductor is shown schematically in each of the slots, multiple conductors may be located in each of the slots. Each of the slot connectors 222-1 to 222-n may support a plurality of differential signal pairs corresponding to the conductors 228-1 to 228-n. The signal pairs may be grouped to provide a plurality of bi-directional data channels associated with each of the node slots.

In an ATCA backplane, for example, the slot connectors 221-1 to 222-n may be data transport connectors providing data transport interfaces, such as a fabric interface configured to support different fabric topologies and a base interface configured to support 10/100/1000 BASE-T Ethernet connections between boards in the chassis. Each of the data transport connectors include a plurality of interface pins corresponding to differential signal pairs. In an ATCA backplane, for example, a fabric interface may include 240 fabric interface pins corresponding to 120 signal pairs and a base interface may include 128 base interface pins corresponding to 64 signal pairs. Each of the data transport interfaces may allocate a number of pins to a channel. A fabric channel provided by the fabric interface, for example, may include eight (8) signal pairs (i.e., four pairs in each direction) provided on sixteen (16) fabric interface pins (e.g., two rows of 8 pins on the data transport connector). Thus, the fabric interface in a node slot of an ATCA chassis may support 15 channels.

The interconnect system 200 may include at least one RTM 230 and a plurality of external signal paths 232-1 to 232-n, which couple the node boards 210-1 to 210-n to the switch board 218. The RTM 230 may be positioned on the second side of the backplane 220 and coupled to the switch board 218 via RTM connector 236 on the RTM 230 that connects to a mating board connector 216 on the switch board 218. In an ATCA chassis, for example, the RTM connector and mating board connectors 216 are Zone 3 connectors located in a reserved space above the backplane 220.

The external signal paths 232-1 to 232-n may be coupled to the conductors 228-1 to 228-n at the second side of the backplane 220 and to the RTM 230. The external signal paths 232-1 to 232-n are thus external to the backplane 220 (as opposed to signal traces routed through the backplane 220). The external signal paths 232-1 to 232-n may be conductive paths configured to carry node board signals between the RTM 230 and the node boards 210-1 to 210-n. Although the signals paths 232-1 to 232-n are shown schematically as a single line from each of the node slots to the RTM 230, the signal paths 232-1 to 232-n include a plurality of conductive paths from each of the node slots to the RTM 230.

In an ATCA chassis, external signal paths 232-1 to 232-n may be coupled to individual fabric interface pins and base interface pins of the data transport connectors. In a star topology, for example, all 240 fabric interface pins of each node slot may be connected to a single switch board. In a dual star topology, 120 fabric interface pins of each node slot may be connected to one switch board and the remaining 120 fabric interface pins of each node slot may be connected to a redundant switch board. Thus, all 240 fabric interface pins in each node slot of an ATCA chassis may be used to connect to a fabric switch providing a wider fabric interface that enables greater bandwidth to remove bottlenecks.

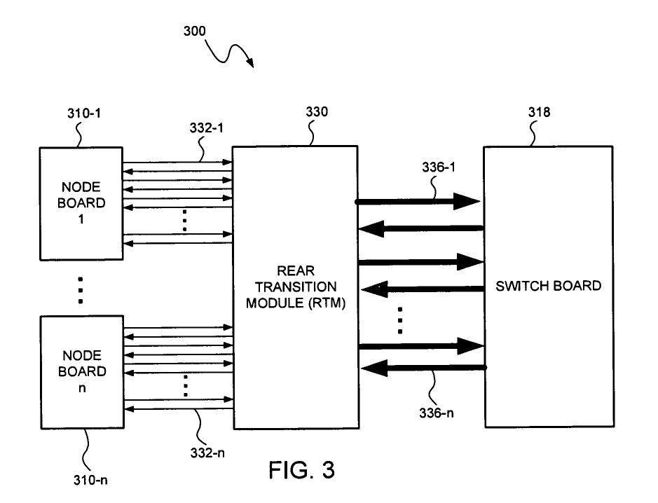

According to one embodiment of an interconnect system 300, shown in FIG. 3, a rear transition module (RTM) 300 may provide conversion between node board signals 332-1 to 332-n received and transmitted by the node boards 310-1 to 310-n and switch board signals 336-1 to 336-n received and transmitted by the switch board 318. The switch board signals 336-1 to 336-n may be fewer in number and higher in bandwidth than the node board signals 332-1 to 332-n. In one example, four (4) node board signals (e.g., 4 differential signal pairs), each having a bandwidth of about 2.5 Gb/s, may be converted to a single switch board signal having a bandwidth of about 10 Gb/s.

In one embodiment, the RTM 300 may provide conversion between electrical node board signals 332-1 to 332-n and optical switch board signals 336-1 to 336-n. Thus, the connectors between the RTM 330 and the switch board 318 (e.g., RTM connector 236 and switch board connector 216 shown in FIG. 2) may be optical connectors providing an optical interface between the RTM 330 and the switch board 318. The RTM 300 may include circuitry to provide the electrical/optical conversion, modulation, multiplexing, and protocol conversion that may be used in an optical interconnect, as known to those skilled in the art. According to one example, synchronous optical network/synchronous digital hierarchy (SONET/SDH) standards may be used and such circuitry may include multi-speed SONET/SDH cell/packet framers such as the type available from Intel Corporation under the names IXF6048 and IXF6012.

Those skilled in the art will also recognize that other interconnect technologies may also be used to convert a large number of node board signals into fewer switch board signals having a higher bandwidth. The RTM 330 may provide, for example, a high performance copper interconnect or a laser interconnect. According to one example, a laser interconnect may include a two dimensional VCSEL (Vertical-Cavity Surface-Emitting Laser) array, which produces output beams that may be directly coupled to fibers.

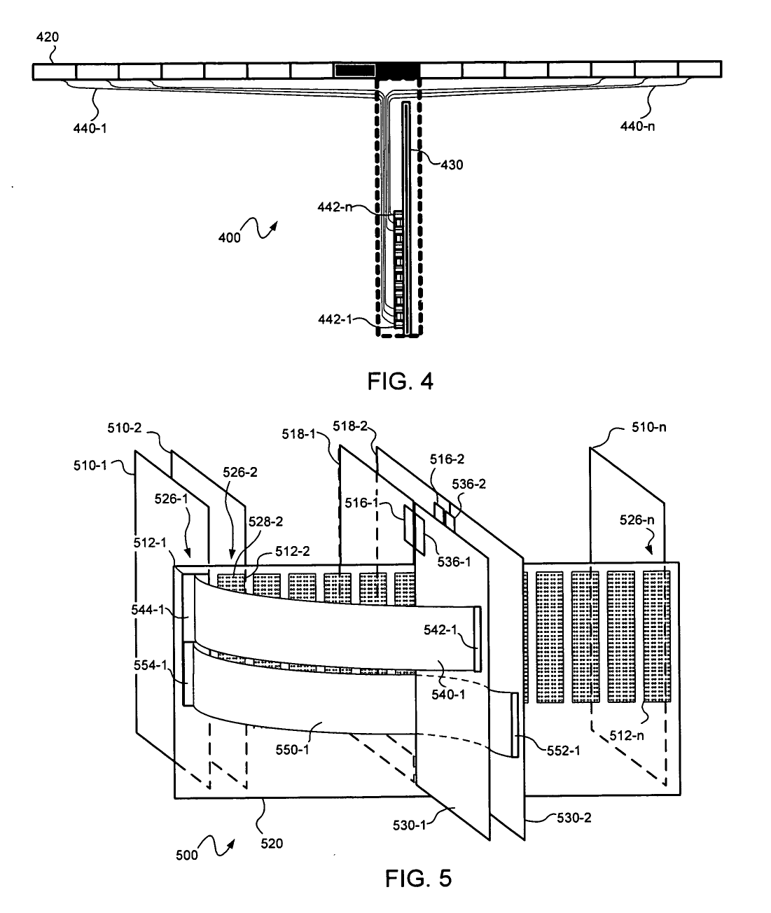

Referring to FIG. 4, one embodiment of an interconnect system 400 may include flexible film circuits 440-1 to 440-n including the external signal paths, which are suitable for many high frequency connections. The flexible film circuits 440-1 to 440-n may be routed between the node slots of a backplane 420 and a rear transition module (RTM) 430 connected to a switch board (not shown). Although FIG. 4 shows flexible film circuits between the three nodes at each end of the backplane 420, flexible film circuits may be routed between each of the node slots and the RTM 430. The flexible film circuits 440-1 to 440-n may include a dielectric substrate (e.g., polyimide or epoxy) and conductors (e.g., copper) through the dielectric substrate. One example of a flexible film circuit that may be used is the type available from 3M Corportation.

Each of the flexible film circuits 440-1 to 440-n may include conductors corresponding to the conductors (e.g., pins) at each node slot of the backplane 420. One or more flexible film circuits may be connected to each node slot. In one embodiment, the flexible film circuits 440-1 to 440-n may be soldered at one end to the node slot interface pins at the rear side of the backplane 420. The flexible film circuits 440-1 to 440-n may be connected at the other end to connectors 442-1 to 442-n, which connect to the RTM 430. The connectors 442-1 to 442-n may be high frequency impedance matched connectors known to those skilled in the art. Alternatively, the flexible film circuits 440-1 to 440-n may be soldered to the RTM 430.

FIG. 5 shows an interconnect system 500 for interconnecting two switch boards 518-1, 518-2 with node boards 510-1 to 510-n. Flexible film circuits 540-1, 550-1 may be routed from a node slot 526-1 to respective rear transition modules (RTMs) 530-1, 530-2 and connected to RTMs 530-1, 530-2, for example, using connectors 542-1, 552-1. RTMs 530-1, 530-2 may be connected to the corresponding switch boards 518-1, 518-2 via mating connectors 516-1, 536-1 and 516-2, 536-2. The RTMs 530-1, 530-2 may be spaced from the backplane 520 such that a flexible film circuit 550-1 may be routed between one RTM 530-1 and the backplane 520 to connect the flexible film circuit 550-1 to the other RTM 530-2. Although flexible film circuits 540-1, 550-1 are shown connected to one node slot 526-1 in FIG. 5, flexible film circuits may be routed from each of the node slots to both RTMs 530-1, 530-2 and node boards 510-1 to 510-n may be connected to each of the node slots. Flexible film circuits routed from the other side of the RTMs (e.g., from slot 526-n) may also pass between the space between the RTMs 530-1, 530-2 and the backplane 520. Flexible film circuits 530-1, 530-2 may also be tied down within the chassis, for example, using glue or tape to secure the flexible film circuits to the backplane 520 or other structures within the chassis.

As shown in greater detail in FIG. 5, a node slot (e.g., node slot 526-2) may include a plurality of conductors (e.g., pins 528-2) extending from the node slot connector (e.g., connector 512-2) through the backplane 520. The conductors (not shown) in the flexible film circuits 540-1, 550-1 may be electrically coupled to respective pins extending from the node slot connector 512-1 at the node slot 526-1, for example, via node end connectors 544-1, 554-1 at a node end of the flexible film circuits 540-1, 550-1. Alternatively, the flexible film circuits 540-1, 550-1 may be soldered to the pins extending from the node slot connector 512-1.

Although the embodiments described above include flexible film circuits, other types of structures may be used to provide the external signal paths between the node slots and the RTM(s). The external signal paths may be provided, for example, using coaxial ribbon cables, discrete coaxial cables, or other cables capable of carrying high frequency signals.

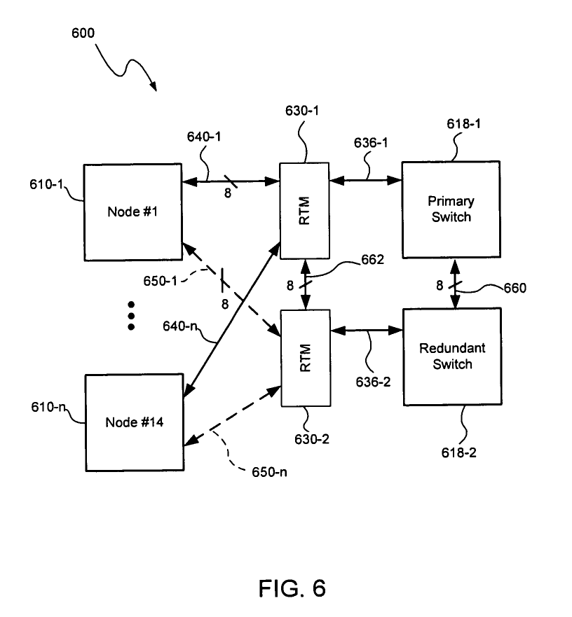

Referring to FIG. 6, one embodiment of a computer system 600 includes a plurality of node boards 610-1 to 610-n interconnected using redundant switch boards 618-1, 618-2 in a dual star topology. The system 600 may include rear transition modules (RTMs) 630-1, 630-2 coupled to each of the switch boards 618-1, 618-2, for example, using optical interfaces 636-1, 636-2. Eight (8) channels 640a-1 to 640a-n may be provided between each of the node boards 610-1 to 610-n and the first RTM 630-1 and eight (8) channels 650-1 to 650-n may be provided between each of the node boards 610-1 to 610-n and the second RTM 630-2. The channels 640-1 to 640-n and 650-1 to 650-n may be provided using external signal paths, such as flexible film circuits, as described above.

The switch boards 618-1, 618-2 may also be coupled together to provide communication directly between the switch boards 618-1, 618-2. The switch boards 618-1, 618-2 may be coupled together, for example, using a direction connection 660 (e.g., through traces in the backplane). The switch boards 618-1, 618-2 may also be coupled together using an indirect connection 662 between the RTMs 630-1, 630-2, for example, using a flexible film circuit, a coaxial ribbon cable, or a fiber optic cable.

In an ATCA embodiment, the fabric interface and the base interface may be used to obtain eight (8) channels of interconnectivity to each switch board 618-1, 618-2. In an ATCA backplane, the fabric interface may provide only 15 fabric channels (e.g., 240 fabric interface pins) per node slot. To obtain 16 channels (e.g., 8 channels to each switch) for each node slot, unused node base interface pins (e.g., 16 additional pins) in the base interface of each node slot may be used to gain an extra channel for each node slot.

By providing eight channels of interconnectivity between each node board and each switch board, the computer system 600 may implement X32 PCI Express links according to a PCI Express serial bus architecture that complies with, for example, Peripheral Component Interconnect (PCI) Express Base Specification Revision 1.0, published Jul. 22, 2002 (the “PCI Express Specification”). In an ATCA chassis, for example, each of the channels includes eight (8) differential pairs, which correspond to an X4 PCI Express link. Eight channels thus corresponds to an X32 PCI Express link (e.g., X4*8=X32). Thus, the computer system 600 may include a X32 PCI Express link width from each node board 610-1 to 610-n to each switch board 618-1, 618-2.

Alternatively other numbers of channels may be provided between the node boards 610-1 to 610-n and switch boards 618-1, 618-2. Fourteen (14) fabric channels may be used, for example, to provide seven (7) channels of interconnectivity between each node board 610-1 to 610-n and each switch board 618-1, 618-2 (e.g., without having to use the base interface in an ATCA chassis). Although an ATCA chassis is capable of supporting fourteen node boards, other numbers of node boards may be interconnected using the embodiments described above.

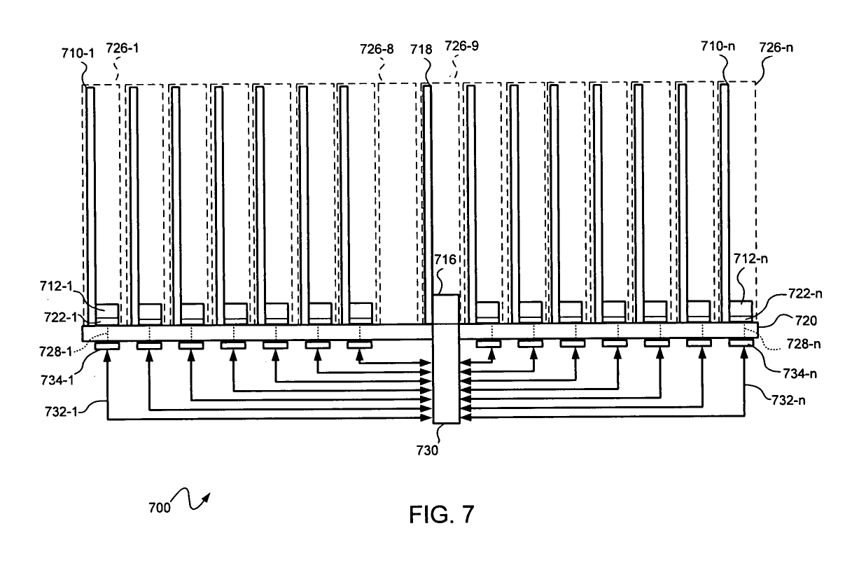

According to an alternative embodiment, shown in FIG. 7, an interconnect system 700 may interconnect node boards 710-1 to 710-n and at least one switch board 718 without using a rear transition module (RTM). The interconnect system 700 may include a connector 730, a plurality of external signal paths 732-1 to 732-n, and a plurality of interconnect modules 734-1 to 734-n, which couple the node boards 710-1 to 710-n to the switch board 718. The interconnect modules 734-1 to 734-n may be located on the second side of the backplane 720 and coupled to respective conductors 728-1 to 728-n at each of the node slots. The interconnect modules 734-1 to 734-n may provide conversion between electrical node board signals received and transmitted on the conductors 728-1 to 728-n and optical switch board signals transmitted to and received from switch board 718, as described above. The external signal paths 732-1 to 732-n may include optical fibers in a fiber optic cable configured to carry optical switch board signals. The connector 730 may include an optical connector connected to the optical fibers and may be connected to an optical connector 716 on the switch board 718.

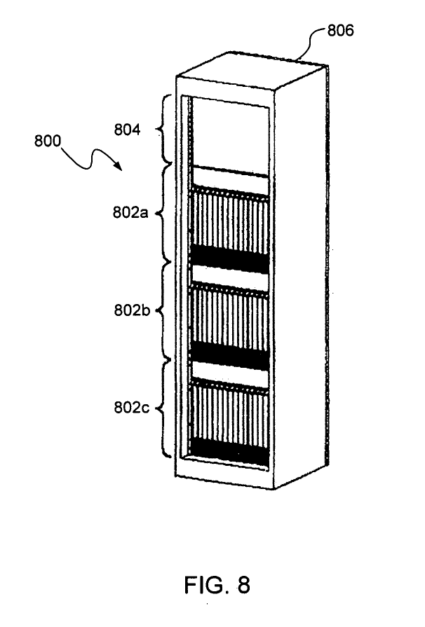

Referring to FIG. 8, a system 800 may include a frame or cabinet 806 that accommodates and electrically couples a plurality of shelves or chassis 802a, 802b, 802c. According to one example, a cabinet 806 may be provided by a telecommunications equipment manufacturer (TEM) to house telecommunications equipment. One or more of the chassis 802a, 802b, 802c may include node boards and at least one switch board interconnected consistent with any embodiment described herein. The cabinet 806 may include, for example, a power supply for providing power to each of the individual chassis 802a, 802b, 802c and other equipment 804 (e.g., alarms, power distribution units, etc.) disposed in the cabinet 806. Additionally, as mentioned above, the cabinet 806 may electrically couple one or more of the chassis 802a, 802b, 802c to at least one other chassis.

According to an alternative embodiment, rather than being disposed in a common cabinet, a system consistent with the present disclosure may include a plurality of chassis that may be individually hardwired to one another without a cabinet. One or more of the plurality of chassis may include node boards and at least one switch board interconnected consistent with any embodiment described herein. Additionally, each of the plurality of chassis may be powered by an individual power supply and/or may be separately powered by a common power supply. Such a system may, therefore, provide a greater freedom in the physical arrangement and interrelation of the plurality of chassis.

Consistent with one embodiment, a system may include a chassis including a backplane having a first side and a second side and a plurality of node slots and at least one switch slot on the first side. The node slots may include respective slot connectors configured to be connected to mating connectors on node boards, and conductors extend from the slot connectors through the backplane to the second side of the backplane. At least one rear transition module (RTM) may be configured to be located on the second side of the backplane opposite the switch slot. The RTM includes an RTM connector configured to be connected to at least one switch board in the switch slot. External signal paths located external to the backplane may be configured to be coupled between the conductors associated with the node slots and the RTM.

Consistent with another embodiment, a system may include a chassis including a backplane having a first side and a second side and a plurality of node slots and at least one switch slot on the first side. The switch slot includes at least one switch slot connector and the node slots include respective node slot connectors. Conductors extend from the node slot connectors through the backplane to the second side of the backplane. A plurality of node boards may be configured to be located in the node slots and including node board connectors configured to be connected to the node slot connectors on the backplane. At least one switch board may be configured to be located in the switch slot and including at least first and second switch board connectors. The first switch board connector is configured to be connected to the switch slot connector on the backplane. An interconnect system may be configured to couple the switch board to the node boards. The interconnect system is located external to the backplane and is configured to be connected to the conductors at the second side of the backplane and connected to the second switch board connector on the switch board.

Consistent with a further embodiment, a system may include a cabinet comprising a plurality of chassis, at least one of the chassis being an Advanced Telecommunications Computing Architecture (ATCA) chassis. The ATCA chassis may include a backplane having a first side and a second side and including a plurality of node slots and at least one switch slot on the first side. The switch slot includes at least one switch slot connector and the node slots include respective node slot connectors. Conductors extend from the node slot connectors through the backplane to the second side of the backplane. A plurality of node boards may be located in the node slots and may include node board connectors connected to the node slot connectors on the backplane. At least one switch board may be located in the switch slot and may include at least first and second switch board connectors. The first switch board connector may be connected to the switch slot connector on the backplane. At least one rear transition module (RTM) may be located on the second side of the backplane opposite the switch board and may include an RTM connector connected the switch board. External signal paths located external to the backplane may be coupled between the conductors associated with the node slots and the RTM.

Consistent with yet another embodiment, a method may include providing a chassis including a backplane configured to interconnect a plurality of node boards and at least one switch board. A plurality of channels may be associated with the node slots in the chassis, and a plurality of conductors may be associated with the channels. The conductors extend through the backplane to a rear of the backplane. The method may also include connecting at least one switch board to at least one switch board slot and coupling external signal paths between conductors associated with channels at the rear of the backplane and the second switch board connector of the switch board. The external signal paths are external to the backplane.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A system comprising:
a chassis including a backplane having a first side and a second side, said backplane including a plurality of node slots and at least one switch slot on said first side, wherein said node slots include respective slot connectors configured to be connected to mating connectors on node boards, wherein conductors extend from said slot connectors through said backplane to said second side of said backplane;
at least one rear transition module (RTM) configured to be located on said second side of said backplane opposite said at least one switch slot, wherein said RTM includes an RTM connector configured to be connected to at least one switch board in said at least one switch slot; and
external signal paths configured to be coupled between said conductors associated with said node slots and said RTM, said external signal paths being located external to said backplane.

2. The system of claim 1 wherein said at least one RTM is configured to provide conversion between node board signals received and transmitted on said signal paths and switch board signals received by and transmitted to said at least one switch board, and wherein said second switch board signals have a higher bandwidth than said node board signals.

3. The system of claim 1 wherein said at least one RTM is configured to provide conversion between electrical node board signals received and transmitted on said signal paths and optical switch board signals received by and transmitted to said at least one switch board, and wherein said RTM connector includes an optical connector configured to mate with an optical connector on said at least one switch board.

4. The system of claim 1 wherein said external signal paths are configured to provide at least eight data channels associated with each of said node slots, each of said data channels including eight differential signal pairs.

5. The system of claim 1 wherein said external signal paths are included in a plurality of flexible film circuits configured to be coupled to respective node slots.

6. The system of claim 5 wherein said flexible film circuits include connectors coupled to at least one end.

7. The system of claim 5 wherein said conductors at each of said node slots are configured to provide at least eight channels, and wherein each of said flexible film circuits provides signal paths for said at least eight channels.

8. The system of claim 1 wherein said chassis is an Advanced Telecommunications Computing Architecture (ATCA) chassis.

9. The system of claim 8 wherein said external signal paths are configured to be coupled to fabric interface pins and base interface pins.

10. The system of claim 1 wherein said backplane includes fourteen node slots and two switch slots.

11. A system comprising:
a chassis including a backplane having a first side and a second side, said backplane including a plurality of node slots and at least one switch slot on said first side, wherein said at least one switch slot includes at least one switch slot connector, wherein said node slots include respective node slot connectors, wherein conductors extend from said node slot connectors through said backplane to said second side of said backplane;
a plurality of node boards configured to be located in said node slots, wherein said node boards include node board connectors configured to be connected to said node slot connectors on said backplane;
at least one switch board configured to be located in said at least one switch slot, said switch board including at least first and second switch board connectors, wherein said first switch board connector is configured to be connected to said at least one switch slot connector on said backplane; and
an interconnect system configured to couple said at least one switch board to said node boards, wherein said interconnect system is configured to be connected to said conductors at said second side of said backplane and connected to said second switch board connector on said switch board, and said interconnect system being located external to said backplane.

12. The system of claim 11 wherein said interconnect system includes:
at least one rear transition module (RTM) located in at least one RTM slot on said second side of said backplane opposite said at least one switch board and coupled to said switch board; and
external signal paths coupled between said conductors associated with said node slots and said RTM.

13. The system of claim 12 wherein said external signal paths are included in a plurality of flexible film circuits coupled to said conductors at respective said node slots and to said RTM.

14. The system of claim 12 wherein said at least one RTM is configured to provide conversion between electrical node board signals received and transmitted on said external signal paths and optical switch board signals received by and transmitted to said at least one switch board, and wherein said RTM includes an optical connector configured to mate with an optical connector on said at least one switch board.

15. The system of claim 11 wherein said interconnect system includes:
a plurality of interconnect modules coupled to said conductors on said second side of said backplane at respective said node slots, said interconnect modules configured to provide conversion between electrical node board signals received and transmitted on said conductors and optical switch board signals received by and transmitted to said at least one switch board; and
optical cables connected between said interconnect modules and said second switch board connector on said switch board.

16. The system of claim 11 wherein said interconnect system is configured to provide at least eight data channels between each of said node boards and said at least one switch board, each of said data channels including eight differential signal pairs.

17. The system of claim 11 wherein said chassis is an Advanced Telecommunications Computing Architecture (ATCA) chassis.

18. The system of claim 17 wherein said interconnect system is configured to be coupled to fabric interface pins and base interface pins.

19. The system of claim 11 wherein said backplane includes fourteen node slots and two switch slots.

20. A system comprising:
a cabinet comprising a plurality of chassis, at least one of said plurality of chassis being an Advanced Telecommunications Computing Architecture (ATCA) chassis;
said ATCA chassis comprising:
a backplane having a first side and a second side, said backplane including a plurality of node slots and at least one switch slot on said first side, wherein said at least one switch slot includes at least one switch slot connector, wherein said node slots include respective node slot connectors, wherein conductors extend from said node slot connectors through said backplane to said second side of said backplane;
a plurality of node boards located in said node slots, said node boards including node board connectors connected to said node slot connectors on said backplane;
at least one switch board located in said at least one switch slot, said switch board including at least first and second switch board connectors, said first switch board connector being connected to said at least one switch slot connector on said backplane;
at least one rear transition module (RTM) located on said second side of said backplane opposite said at least one switch board, wherein said RTM includes an RTM connector connected to said at least one switch board; and
external signal paths coupled between said conductors associated with said node slots and said RTM, said external signal paths being located external to said backplane.

21. The system of claim 20 wherein said at least one RTM is configured to provide conversion between electrical node board signals received and transmitted on said signal paths and optical switch board signals received by and transmitted to said at least one switch board, and wherein said RTM connector includes an optical connector configured to mate with an optical connector on said at least one switch board.

22. The system of claim 20 wherein said external signal paths are included in a plurality of flexible film circuits coupled between respective said node slots and said RTM.

23. The system of claim 20 wherein said external signal paths are configured to provide at least eight data channels between each of said node boards and said at least one switch board, each of said data channels including eight differential signal pairs.

24. A method comprising:
providing a chassis including a backplane configured to interconnect a plurality of node boards and at least one switch board, said backplane including a plurality of node slots configured to receive said node boards and at least one switch slot configured to receive said switch board, said node slots including node slot connectors configured to connect to node board connectors on said node boards and said switch slots including switch slot connectors configured to connect to switch board connectors on said switch boards, wherein a plurality of channels are associated with said node slots in said chassis, wherein a plurality of conductors associated with said channels extend from said node slot connectors through said backplane to a rear of said backplane;
connecting at least one switch board to said at least one switch board slot, said switch board including at least first and second switch board connectors, said first switch board connector being connected to at least one of said switch slot connectors on said backplane; and
coupling external signal paths between said conductors associated with said channels at said rear of said backplane and said second switch board connector of said switch board, said external signal paths being external to said backplane.

25. The method of claim 24 wherein coupling said external signal paths comprises:
coupling said signal paths to a rear transition module (RTM); and
connecting said RTM to said switch board via said second switch board connector.

26. The method of claim 25 wherein said RTM is configured to provide conversion between electrical signals received and transmitted on said signal paths and optical signals received by and transmitted to said at least one switch board, and wherein said RTM includes an optical connector configured to mate with an optical connector on said at least one switch board.

27. The method of claim 24 wherein coupling said external signal paths comprises:
connecting a plurality of flexible film circuits to respective said conductors associated with said channels;
connecting said plurality of flexible film circuits to a rear transition module (RTM); and
connecting said RTM to said switch board via said second switch board connector.

28. The method of claim 24 wherein coupling said external signal paths comprises:
connecting interconnect modules to said conductors at respective said nodes, wherein said interconnect modules are configured to provide conversion between electrical signals received and transmitted on said conductors and optical signals received by and transmitted to said at least one switch board; and
connecting optical cables between said interconnect modules and said second switch board connector of said switch board, wherein said second switch board connector includes an optical connector.

29. The method of claim 24 further comprising connecting a plurality of node boards to said node slots.

30. The method of claim 24 wherein said chassis is an Advanced Telecommunications Computing Architecture chassis.
